(19) United States
(12) Patent Application Publication
(10) Pub. No.: US 2018/0332256 A1
(43) Pub. Date: Nov. 15, 2018

(54) COARSE-GRAINED MULTILAYER FLOW INFORMATION DYNAMICS FOR MULTISCALE MONITORING

(71) Applicant: HRL Laboratories, LLC, Malibu, CA (US)

(72) Inventors: Kang-Yu Ni, Calabasas, CA (US); Tsai-Ching Lu, Thousand Oaks, 91 (US)

(21) Appl. No.: 16/033,178

(22) Filed: Jul. 11, 2018

Related U.S. Application Data
(63) Continuation-in-part of application No. 15/497,202, filed on Apr. 25, 2017.
(60) Provisional application No. 62/376,220, filed on Aug. 17, 2016.
(60) Provisional application No. 62/557,733, filed on Sep. 12, 2017.

(51) Int. Cl. H04N 7/18; G06T 7/13; G06K 9/46; G06T 7/11; G06T 7/136; G06F 17/16; H04N 5/232; G05D 1/10; B64C 39/02

(52) U.S. Cl. CPC H04N 7/183; G06T 7/13; G06K 9/4638; G06T 7/11; G06T 7/136; G06T 2207/30242; H04N 5/23296; G05D 1/101; B64C 39/024; B64C 2201/123; B64C 2201/127; G06F 17/16

(57) ABSTRACT

Described is a system for multiscale monitoring. During operation, the system receives surveillance data of a scene having a plurality of zones. The surveillance data includes an object flow tensor V indicating a number of objects flowing from one zone to another zone at time t and an object communication tensor C indicating a number of communications sending from one zone to another zone at time t. The system then determines a cluster membership of the plurality of zones. Dependency links between communications and flows are then determined. At least one cluster of one or more zones is designated as a region of interest based on the dependency links, which allows the system to control a device based on the designated region(s) of interest.

### CROSS-REFERENCE TO RELATED APPLICATIONS

The present application is a Continuation-in-Part application of U.S. application Ser. No. 15/497,202, filed on Apr. 25, 2017, which is a non-provisional application of U.S. Provisional Application No. 62/376,220, filed on Aug. 17, 2016, the entirety of which are incorporated herein by reference.

The present application is ALSO a non-provisional patent application of U.S. Provisional Application No. 62/557,733 filed on Sep. 12, 2017, the entirety of which is hereby incorporated by reference.

### GOVERNMENT RIGHTS

This invention was made with government support under U.S. Government Contract Number PC 1141899 issued by the National Reconnaissance Office via the Boeing Company. The government has certain rights in the invention.

### BACKGROUND OF INVENTION

### (1) Field of Invention

The present invention relates to monitoring system and, more specifically, to a system for multiscale monitoring using coarse grained, multilayer flow information dynamics.

### (2) Description of Related Art

Monitoring systems are often employed to observe and monitor a wide variety of complex systems. While monitoring a single data source is seemingly simple, monitoring large-scale, heterogeneous data sources can be incredibly complicated and is subject to error. Some prior art (see the List of Incorporated Literature References, Literature Reference No. 4) was developed to provide a new capability to analyze multiple heterogeneous data sources with a multilayer information dynamic framework, whereas other prior art (see Literature References No. 2 and 5) considered only single data sources.

While attempts have been to make sense of large-scale, heterogeneous data, the prior art still lacks the ability to extend the multilayer information dynamic framework to model multiple scales (e.g. spatial scales), so that the limited computation resources can be efficiently utilized. Thus, a continuing need exists for a system for multiscale monitoring using coarse grained, multilayer flow information dynamics to allow for efficient resource allocation.

### SUMMARY OF INVENTION

This disclosure provides a system for multiscale monitoring. In various aspects, the system comprises one or more processors and a memory, the memory being a non-transitory computer-readable medium having executable instructions encoded thereon, such that upon execution of the instructions, the one or more processors perform several operations, such as receiving surveillance data of a scene having a plurality of zones, the surveillance data having an object flow tensor V indicating a number of objects flowing from one zone to another zone at time t and an object communication tensor C indicating a number of communications sending from one zone to another zone at time t; determining a cluster membership of the plurality of zones; determining dependency links between communications and flows; designating at least one cluster of one or more zones as a region of interest based on the dependency links; and controlling a device based on the region of interest.

In another aspect, determining a cluster membership of the plurality of zones further comprises operations of constructing an adjacency matrix A based on the object flow tensor V; symmetrizing the adjacency matrix A; solving nonnegative matrix factorization of the symmetrized adjacency matrix; and assigning cluster membership of the objects in each of the plurality of zones to generate the cluster membership.

In yet another aspect, determining dependency links between communications and flows further comprises operations of constructing a low-resolution flow tensor based on the cluster membership by merging vessel flows V within each cluster; determining flow transfer entropy; and identifying dependency links and dependent clusters by thresholding.

Additionally, designating at least one cluster of one or more zones as a region of interest based on the dependency links includes designating the dependent clusters as regions of interest.

In another aspect, controlling a device based on the region of interest further comprises causing an unmanned aerial vehicle to move to the region of interest.

Further, controlling a device based on the region of interest further comprises causing surveillance apparatus in a satellite to zoom into the region of interest.

Finally, the present invention also includes a computer program product and a computer implemented method. The computer program product includes computer-readable instructions stored on a non-transitory computer-readable medium that are executable by a computer having one or more processors, such that upon execution of the instructions, the one or more processors perform the operations listed herein. Alternatively, the computer implemented method includes an act of causing a computer to execute such instructions and perform the resulting operations.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The objects, features and advantages of the present invention will be apparent from the following detailed descriptions of the various aspects of the invention in conjunction with reference to the following drawings, where:

FIG. 1 is a block diagram depicting the components of a system according to various embodiments of the present invention;

FIG. 2 is an illustration of a computer program product embodying an aspect of the present invention;

FIG. 3 is a flowchart depicting a process for multiscale monitoring according to various embodiments of the present invention;

FIG. 4 is a multilayer information dynamic model for finding activity dependencies across layers according to various embodiments of the present invention;

FIG. 5 is a schematic illustration of a mixed, coarse-scale multilayer network;

FIG. 6 is an illustration depicting how the multiple spatial scales of the multilayer information dynamic framework offers the ability to zoom in to a region of interest;

FIG. 7 is a schematic illustration of the discovery of inter-layer dependency relations;

FIG. 8 is an illustration showing that flow clustering summarizes vessel flow and reduces the number of flows;

FIG. 9A is an example of a vessel flow graph at full resolution;

FIG. 9B is an example of a vessel flow graph at low-resolution;

FIG. 9C is an example of a vessel flow graph, depicting a multi-scale version; and

FIG. 10 is a block diagram depicting control of a device according to various embodiments.

### DETAILED DESCRIPTION

The present invention relates to monitoring system and, more specifically, to a system for multiscale monitoring using coarse grained, multilayer flow information dynamics. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, first a list of cited references is provided. Next, a description of the various principal aspects of the present invention is provided. Subsequently, an introduction provides the reader with a general understanding of the present invention. Finally, specific details of various embodiment of the present invention are provided to give an understanding of the specific aspects.

### (1) LIST OF INCORPORATED LITERATURE REFERENCES

The following references are cited throughout this application. For clarity and convenience, the references are listed herein as a central resource for the reader. The following references are hereby incorporated by reference as though fully set forth herein. The references are cited in the application by referring to the corresponding literature reference number, as follows:
1. Batty, Michael, et al. “Entropy, complexity, and spatial information.” Journal of geographical systems 16.4 (2014): 363-385.
2. J. Borge-Holthefer, N. Perra, B. Goncalves, S. Gonzalez-Bailon, A. Arenas, Y. Moreno, and A. Vespignani. The dynamics of information-driven coordination phenomena: A transfer entropy analysis, Science Advance, 2:5, e1501158, 2016.
3, Ding, Chris, Xiaofeng He, and Horst D. Simon. “On the equivalence of nonnegative matrix factorization and spectral clustering.” Proceedings of the 2005 SIAM International Conference on Data Mining. Society for Industrial and Applied Mathematics, 2005.
4. U.S. patent application Ser. No. 15/497,202, filed on Apr. 25, 2017, and entitled, “Multilayer Information Dynamics for Activity and Behavior Detection.”
5. N-K. Ni and T-C. Lu, Information Dynamic Spectrum Characterizes System Instability toward Critical Transitions, EPJ Data Science, 3:28, 2014
6. T. Schreiber, Measuring information transfer. Phys Rev Lett 2000, 85(2):461-464. 10.1103/PhysRevLett.85.461
7. C. E. Shannon, A Mathematical Theory of Communication”. Bell System Technical Journal 27 (3): 379-423, 1948.
8. Shi. Lei, Hanghang Tong, Jie Tang, and Chuang Lin. “Vegas: Visual influence graph summarization on citation networks.” IEEE Transactions on Knowledge and Data Engineering 27.12 (2015): 3417-3431.
9. Vandaele, A., Gillis, N., Lei, Q., Zhong, K., & Dhillon, I. “Efficient and non-convex coordinate descent for symmetric nonnegative matrix factorization.” IEEE Transactions on Signal Processing 64.21 (2016): 5571-5584.

### (2) PRINCIPAL ASPECTS

Various embodiments of the invention include three “principal” aspects. The first is a system for multiscale monitoring. The system is typically in the form of a computer system operating software or in the form of a “hard-coded” instruction set. This system may be incorporated into a wide variety of devices that provide different functionalities. The second principal aspect is a method, typically in the form of software, operated using a data processing system (computer). The third principal aspect is a computer program product. The computer program product generally represents computer-readable instructions stored on a non-transitory computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

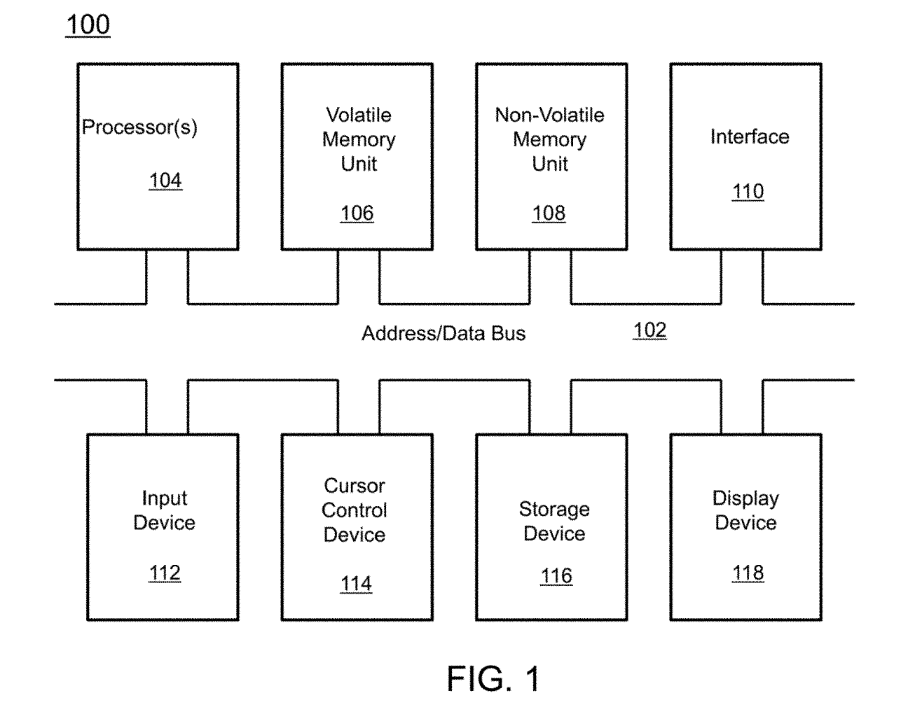

A block diagram depicting an example of a system (i.e., computer system 100) of the present invention is provided in FIG. 1. The computer system 100 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors of the computer system 100. When executed, the instructions cause the computer system 100 to perform specific actions and exhibit specific behavior, such as described herein.

The computer system 100 may include an address/data bus 102 that is configured to communicate information. Additionally, one or more data processing units, such as a processor 104 (or processors), are coupled with the address/data bus 102. The processor 104 is configured to process information and instructions. In an aspect, the processor 104 is a microprocessor. Alternatively, the processor 104 may be a different type of processor such as a parallel processor, application-specific integrated circuit (ASIC), programmable logic array (PLA), complex programmable logic device (CPLD), or a field programmable gate array (FPGA).

The computer system 100 is configured to utilize one or more data storage units. The computer system 100 may include a volatile memory unit 106 (e.g., random access memory (“RAM”), static RAM, dynamic RAM, etc.) coupled with the address/data bus 102, wherein a volatile memory unit 106 is configured to store information and instructions for the processor 104. The computer system 100 further may include a non-volatile memory unit 108 (e.g., read-only memory (“ROM”), programmable ROM (“PROM”), erasable programmable ROM (“EPROM”), electrically erasable programmable ROM “EEPROM”), flash memory, etc.) coupled with the address/data bus 102, wherein the non-volatile memory unit 108 is configured to store static information and instructions for the processor 104. Alternatively, the computer system 100 may execute instructions retrieved from an online data storage unit such as in “Cloud” computing. In an aspect, the computer system 100 also may include one or more interfaces, such as an interface 110, coupled with the address/data bus 102. The one or more interfaces are configured to enable the computer system 100 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the computer system 100 may include an input device 112 coupled with the address/data bus 102, wherein the input device 112 is configured to communicate information and command selections to the processor 100. In accordance with one aspect, the input device 112 is an alphanumeric input device, such as a keyboard, that may include alphanumeric and/or function keys. Alternatively, the input device 112 may be an input device other than an alphanumeric input device. In an aspect, the computer system 100 may include a cursor control device 114 coupled with the address/data bus 102, wherein the cursor control device 114 is configured to communicate user input information and/or command selections to the processor 100. In an aspect, the cursor control device 114 is implemented using a device such as a mouse, a track-ball, a track-pad, an optical tracking device, or a touch screen. The foregoing notwithstanding, in an aspect, the cursor control device 114 is directed and/or activated via input from the input device 112, such as in response to the use of special keys and key sequence commands associated with the input device 112. In an alternative aspect, the cursor control device 114 is configured to be directed or guided by voice commands.

In an aspect, the computer system 100 further may include one or more optional computer usable data storage devices, such as a storage device 116, coupled with the address/data bus 102. The storage device 116 is configured to store information and/or computer executable instructions. In one aspect, the storage device 116 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 118 is coupled with the address/data bus 102, wherein the display device 118 is configured to display video and/or graphics. In an aspect, the display device 118 may include a cathode ray tube (“CRT”), liquid crystal display (“LCD”), field emission display (“FED”), plasma display, or any other display device suitable for displaying video and/or graphic images and alphanumeric characters recognizable to a user.

The computer system 100 presented herein is an example computing environment in accordance with an aspect. However, the non-limiting example of the computer system 100 is not strictly limited to being a computer system. For example, an aspect provides that the computer system 100 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

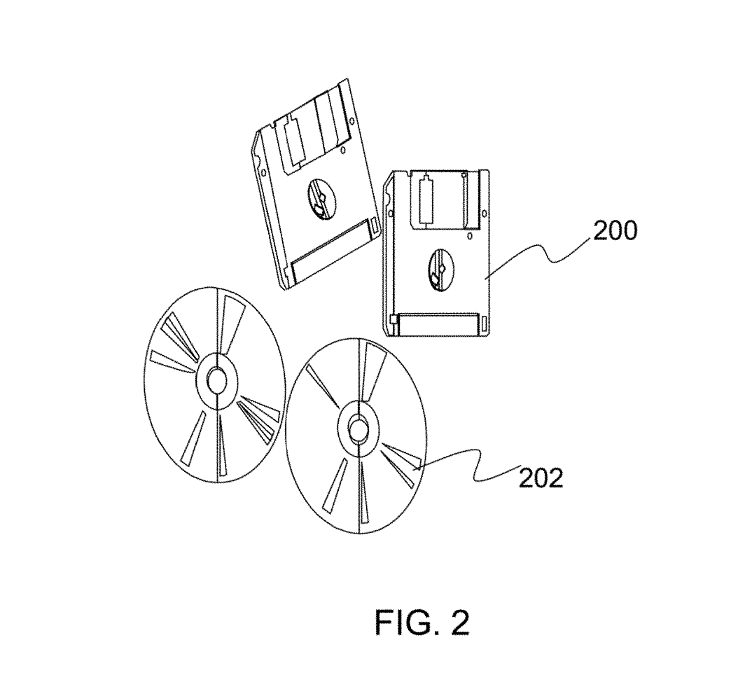

An illustrative diagram of a computer program product (i.e., storage device) embodying the present invention is depicted in FIG. 2. The computer program product is depicted as floppy disk 200 or an optical disk 202 such as a CD or DVD. However, as mentioned previously, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium.

### (3) INTRODUCTION

This disclosure provides a unique multi-scale multilayer graph framework for information dynamics, which analyzes and monitors the relationships of different types of activities and dynamics. Based on a time series of different types of observables (or measurements), the multi-scale multilayer graph representation for information dynamics can be used to detect and infer their dependencies that cannot be directly observed (or measured). The multiple spatial scale formulation of this framework allows the construction of the multilayer graph to adapt to the activities and dynamics to reduce measurement requirements while maintaining the analysis performance. A key aspect that enables this multiple spatial scale within the information dynamic framework is a flow-rate optimization method that merges graph nodes into clusters. The activities can then be summarized on the coarse-grained graph derived from multiscale of derived clusters, which in turn allows the system to cue a region of interest for multiscale monitoring of the dynamics of the system.

A purpose of this invention is to efficiently direct computing resources to monitor and analyze emerging activities from multiple sources at multiple scales. Building upon this team's multilayer information dynamic framework, the advantages of the new feature of the multiscale, multilayer dynamic information are two-fold: 1) It reduces computations without losing the ability to find activity dependencies. The coarse resolution corresponds to sparse activity dependency; therefore, it provides better abstraction and enables coverage of larger graphs. 2) It has the ability to zoom-in or zoom-out of regions of interest in order to provide better actionable insights to an analyst or other system operations.

The system described herein can be deployed as embedded decision support modules in the cloud computing infrastructures or a stand-alone system for the application areas of complex systems, such as intelligence surveillance and reconnaissance (ISR) for posturing maritime activities (as demonstrated), crisis management, social unrests, and financial markets. The successful deployment of this technology is expected to result in detection and inference of system behaviors, activities, and dependency. Further details are provided below.

### (4) SPECIFIC DETAILS OF VARIOUS EMBODIMENTS

(4.1) Method Overview: Multilayer Information Dynamics with Multiple (Spatial) Scales

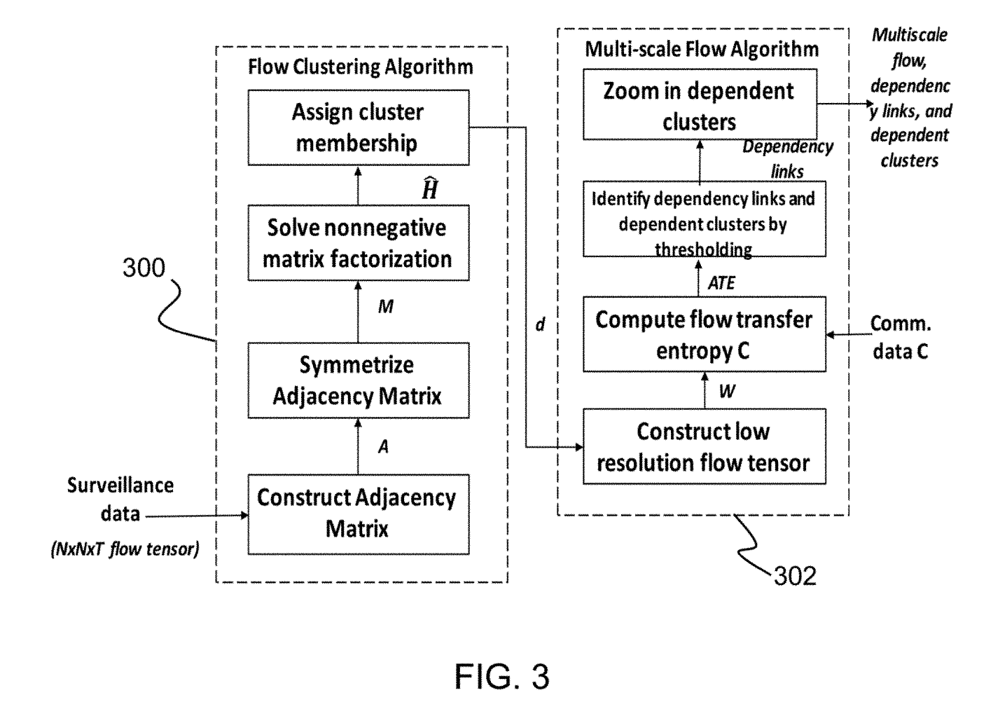

This disclosure provides a multi-scale multilayer graph representation for information dynamics, which from a time series of different observable (or measurement) modalities detects and infers their dependencies that cannot be directly observed (or measured). The multiple spatial scale within the information dynamic framework is developed using a flow-rate optimization model that merges graph nodes into clusters. This process if further illustrated in FIG. 3. More specifically, FIG. 3 illustrates a flowchart depicting a process for multiscale monitoring, including the flow clustering process 300 that receives inputs as a vessel flow tensor and generates cluster membership, following by the multi-scale multilayer information dynamics process 302 that provides dependency links, dependent clusters and corresponding multiscale flow. Further details regarding these processes are provided below.

(4.2) Mixed Coarse-Scale Multilayer Network: Example Scenario (Maritime Activities)

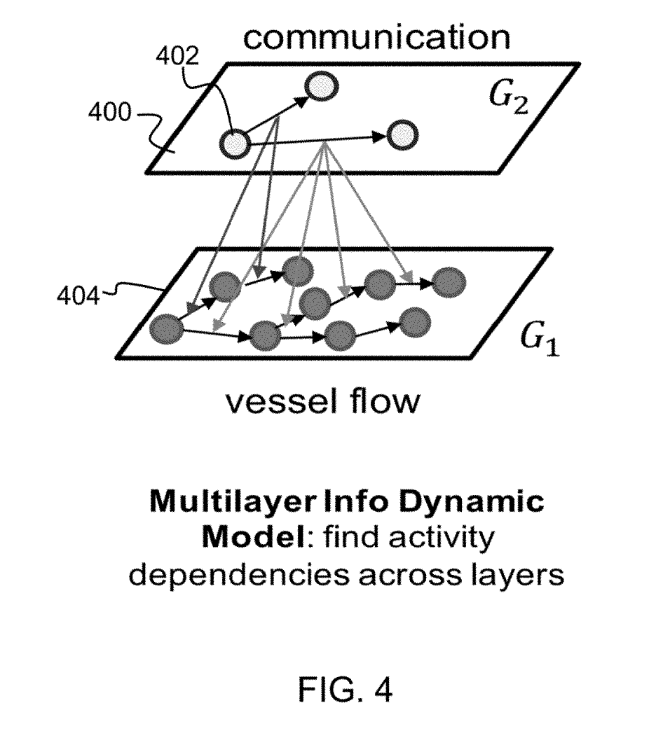

For further understanding, provided below is an example scenario as related to surveillance of maritime activities. As shown in FIG. 4, on the top layer 400 of the multilayer network, the signals are communication activities between nodes 402 (or zones). The nodes 402 indicate zones or area of certain locations, such as exclusive economic zones, ports, etc. These are time series for each pair of nodes 402, which measure the amount of collective communication activities between those zones (all the vessels within each zone). On the bottom layer 404, the signals are vessel flows between nodes, indicating the quantity of vessels flowing from one zone to another over a period of time. One can model how the communication activities influence the vessel flows as follows:

$$\frac{\partial V}{\partial t} = α {Δ}_{{G}_{1. t}} V + β {∇}_{{G}_{2 , t - ɛ}} V . ,$$

where G₁ denotes vessel graph, G₂ denotes communication graph, t denotes time, ε denotes reaction time delay, V denotes vessel density, α denotes diffusion constant, and β denotes coefficient of weighting communication information.

This semi-discrete (continuous in time and discrete in space) partial differential equation describes that the change of vessel density (left-hand side) depends on 1) diffusion of the vessels with the graph Laplacian operator with the vessel graph G₁ and 2) advection of vessels with the graph gradient operator coming from the communication graph G₂ with a small reaction time delay ε. This model generates data in a way that the vessel flows between certain zones depend on the communication activities.

A goal of this multilayer information framework is to discover the hidden dependencies between vessel flows and communication activities (the input data are time series of these), without knowing the model (the equation above) that generates the data. This method was demonstrated with flow transfer entropy (defined below in the flow transfer entropy section) to detect the hidden dependencies, i.e. identification of the vessel flows that depend on certain communication activities.

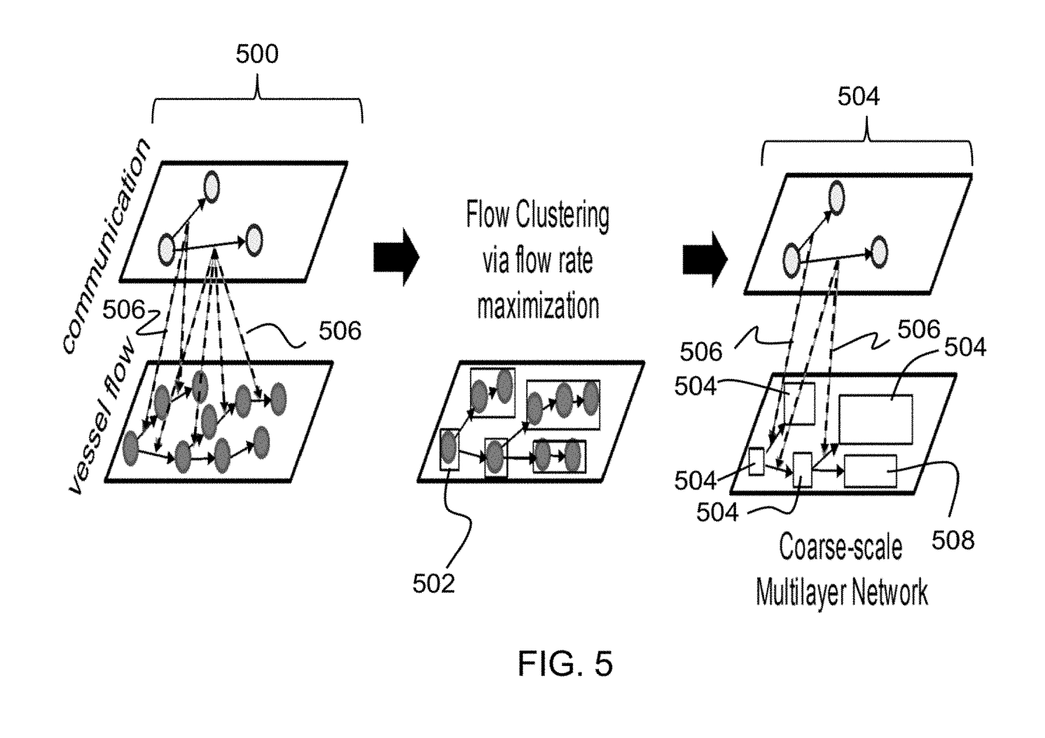

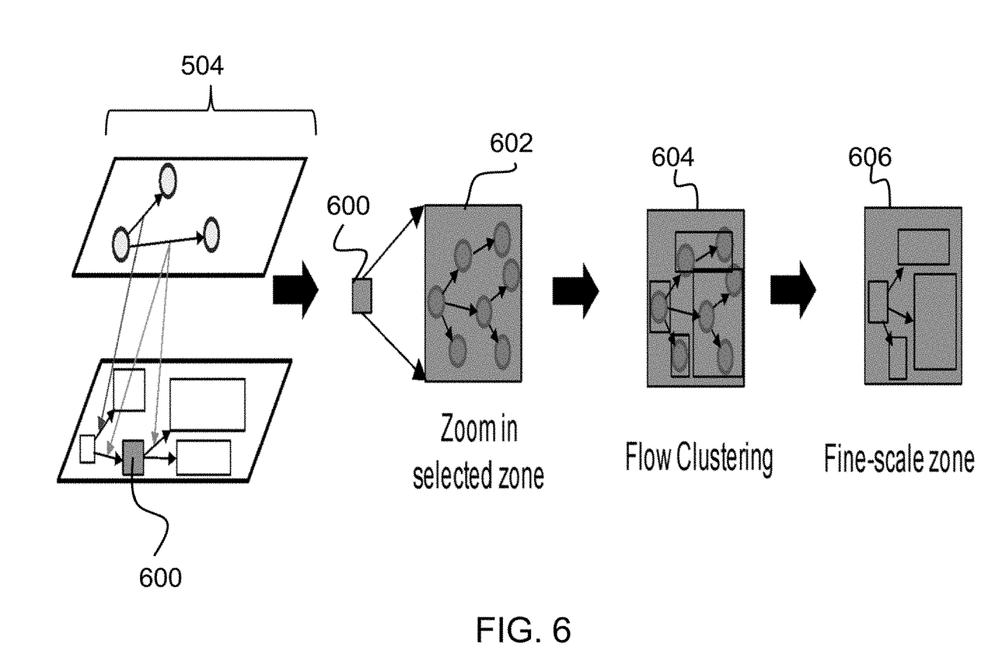

This multilayer information dynamic framework is extended to multiple spatial scales. As noted above, an advantage to extending the framework to multiple spatial scales is that it simplifies the framework and reduces computations without losing the ability to find dependencies (as shown in FIG. 5), and it offers the ability to zoom in region of interest (as shown in FIG. 6). Specifically, FIG. 5 provides a schematic illustration of a mixed, coarse-scale multilayer network. The original scale 500 of multilayer network at the left is processed by a novel flow-clustering algorithm to maximize observed flow rate (middle) and to generate clusters 502 (rectangular boxes) which in turns enables the cross-layer dependency computation among the flow dependency of clustered entities (simplified edges at the right).

Region of interest 504 are identified by the across-layer dependency links 506 (directed edges). As shown on the right of FIG. 5, all the zones that are adjacent of the across-layer dependency links 506 are identified as regions of interest 504. In this simplified illustration, the only zone that is not region of interest is the right bottom zone 508.

Additionally, FIG. 6 provides a schematic illustration of zoom-in and zoom-out capability. The coarse-scale, multilayer network 504 further enables zoom-in to a designated node, such as the selected square node 600 which allows for a zoomed-in selected node 602. As shown, the zoomed-in selected node 602 in this example encompasses 7 nodes. Based on that, the flow clustering process 604 can be continued to provide another level of finer-grained clusters 606.

(4.3) Vessel Flow Clustering:

Suppose the adjacency matrix for the vessel flow graph G₁ is A=(aᵢⱼ)_{i,j=1, . . . , N}, i.e., aᵢⱼ indicates the amount of vessels flowing from zone i to zone j. An approach to multiple spatial scales is the application of flow clustering to merge nodes into k clusters π_{c}, for c=1, 2, . . . , k that highlights the largest [symbol] flows ξₛ, for s=1, 2, . . . , [symbol] , within and across clusters. Flow ξₛ is the collection of all links from nodes in cluster π_{c(s)} to nodes in cluster π_{d(s)}. The flow rate of flow ξₛ is defined as:

$$r ( {ξ}_{s} ) = \frac{{\sum }_{{v}_{i} ∈ {π}_{c ( s )}} , {v}_{j} ∈ {π}_{d ( s )} {a}_{ij}}{\sqrt{\vert {π}_{c ( s )} \vert \vert {π}_{d ( s )} \vert}} ,$$

where ν denotes node, c(s) denotes from nodes, d(s) denotes to nodes, i and j denote zones i and j, respectively, with aᵢⱼ denoting the amount of vessels flowing from zone i to zone j. The flow clustering problem is posed as finding k clusters that maximizes the sum of the flow rate in [symbol] largest intra-cluster or inter-cluster flows. The numbers of clusters k and flows [symbol] are pre-defined. The flow rate maximization problem is optimization problem is as follows:

$$max {\sum }_{s = 1 , … , 𝓁} {r ( {ξ}_{s} )}^{2}$$

The solution to this can be approximated with kernel k-mean clustering (see Literature Reference No. 8), because both aim to maximize the weighted sum of the graph adjacency matrix entries. The kernel k-mean clustering is equivalent to the symmetric nonnegative matrix factorization (NMF) (see Literature Reference No. 3) and can be efficiently solved by coordinate descent methods (see Literature Reference No. 9).

Let M be the symmetrized matrix of the vessel flow adjacency matrix A: M=A+A^{T}. The symmetric NMF aims to find an N×k matrix H (where k<N) with nonnegative entries Hᵢⱼ≥0 that minimizes ∥M−HH^{T}∥_{F}², where ∥·∥_{F} indicates the Frobenius norm.

The difference between the problem being solved here and the problem in Literature Reference No. 8 is the following: the present problem summarizes more general directed graphs, while Literature Reference No. 8 summarizes the influence flows from a single source node in the reversed publication citation graph. In the problem addressed by the present disclosure, the number of sources can be arbitrary.

(4.4) Flow Transfer Entropy

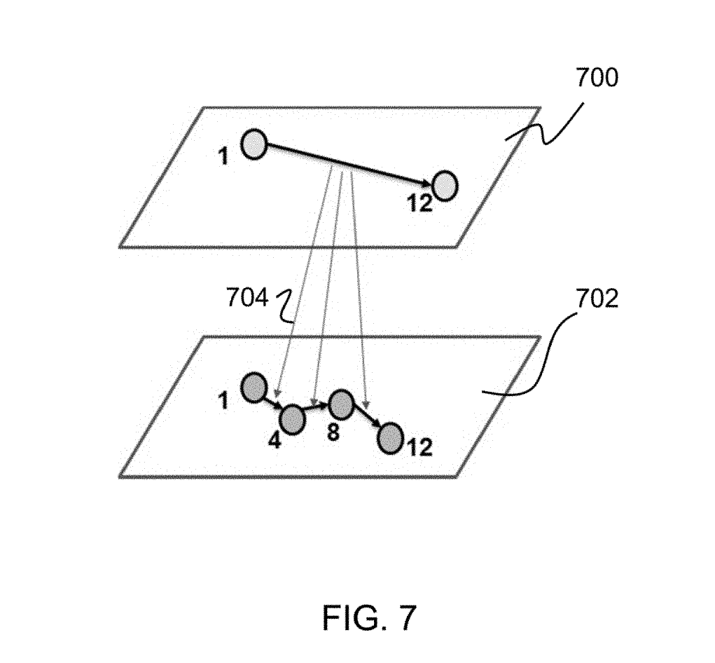

The flows from region Rᵢ to region Rⱼ are denoted as: V_{R}_{ᵢ}_{→R}_{ᵢ}(t) and C_{R}_{ᵢ}_{→R}_{ᵢ}(t) for vessels and communication, respectively. The present method is directed to capturing the dependency of these flows (edges) and their changes across different types of flows. Sensor data (e.g., from a plane, satellite, etc.) can be used to obtain the time series of intra-layer edges observed for each layer (for example, the vessel flows during a fixed time interval changes over time). For i=j, the time series will be density of vessels and communications in each region for the layers: V_{R}_{ᵢ}_{→R}_{ᵢ}(t) and C_{R}_{ᵢ}_{→R}_{ᵢ}(t), respectively. From these flow time series, inter-layer relations are inferred. Since the method is directed to discovering dependency of the flows from one layer to another, the inter-layer edges are between a pair of flows from different layers (as shown in FIG. 7). The dependency is determined by computing ATE: ATE_{ij→kl}(C_{R}_{ᵢ}_{→R}_{ⱼ}(t),V_{R}_{ₖ}_{→R}_{ₗ}(t)). Therefore, these are termed flow transfer entropy.

FIG. 7 provides a schematic illustration of the discovery of inter-layer dependency relations: the communication flow between node 1 and node 12 in the upper panel 700 influences the vessel flows on the path of node 1→4→8→12 in the bottom panel 702. Such flow dependency (edges) between layers are inferred automatically by the ATE methods.

(4.5) Flow Clustering Algorithm

As depicted in FIG. 3, the flow clustering process 300 receives inputs as a vessel flow tensor and, based on that, generates cluster membership. The process is provided below and further depicted in FIG. 3:

Inputs. V and k: An N×N×T vessel flow tensor V where each entry Vᵢⱼₜ indicates the amount of vessels flowing from node i to node j at time t. The number of clusters k.
1. Obtain an N×N adjacency matrix A by summing across time: Aᵢⱼ=ΣₜVᵢⱼₜ.
2. Symmetrize matrix A by M=A+A^{T}.
3. Solve the symmetric NMF problem

$$\hat{H} = {arg min}_{H \geq 0} {‖ M - {HH}^{T} ‖}_{F}^{2} ,$$

H is an N×k matrix.
4. Assign cluster membership, represented by an N×1 vector d where the i^{th} entry is

$${d}_{i} = {arg max}_{j} {H}_{i} ( j ) ,$$

the argument of the largest entry in Hᵢ (the i^{th} row of H).
Output. d: An N×1 vector d that indicates the cluster membership with entries from {1, 2, . . . , k}.

(4.6) Vessel Flow Clustering Example Result

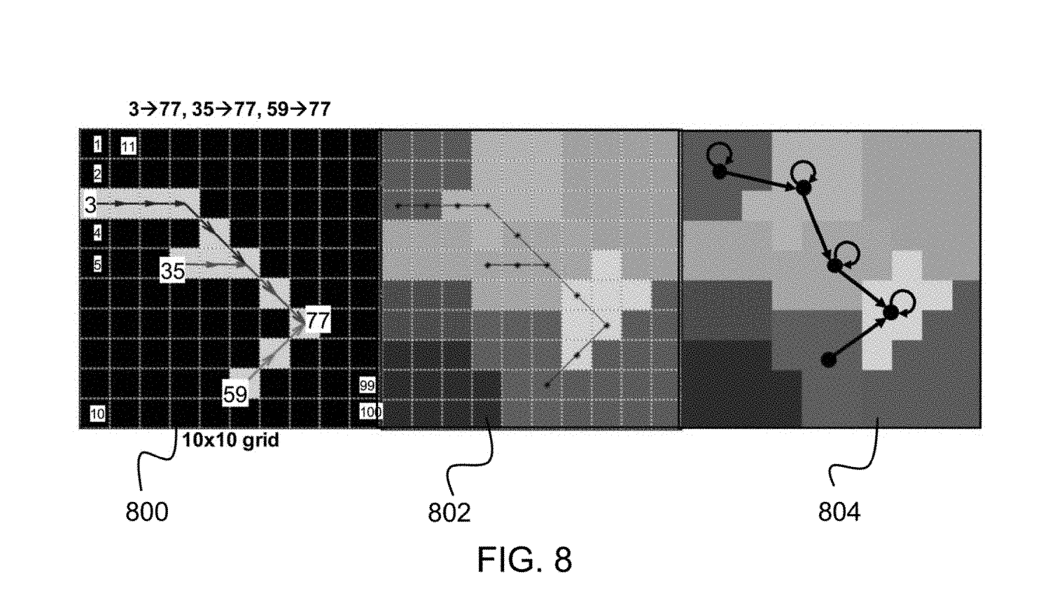

The vessel flow clustering process was performed with a set of data to validate the system and process. Provided below is an example to illustrate that flow clustering summarizes vessel flow and reduces the number of flows. The example graph in FIG. 8 is a 10×10 regular grid (therefore 100 nodes) 800 with three major communications from node 3 to node 77, node 35 to node 77, and node 59 to node 77. The communication frequency of these are 5%, i.e., if the sampling rate is per minute, in average 5 times out of 100 minutes are active. There is also noise communication with a 2% frequency with a pair of nodes randomly picked at each time. The vessel flow is simulated with the partial differential equation described above with random initialization for the vessel density on each node. The grid 800 shows the corresponding vessel flows for the major communications. FIG. 8 also depicts the vessel flow clustering results 802 with 10 clusters, where each cluster is color-coded (nodes with the same color is a cluster). Vessel flow summarization 804 is also depicted, showing the summarized version of the vessel flows in the grid 800. The vessel flow summarization 804 is indicated by the directed edges, showing that the number of flows is reduced.

(4.7) Multi-Scale Multilayer Information Dynamics Algorithm

The system described herein detects communication and vessel flow dependency with low resolution and cue regions of interest with TE for multiscale monitoring (depicted as element 302 in FIG. 3). The process is provided in further detail below:

Inputs. V, C and k: An N×N×T vessel flow tensor V where entry Vᵢⱼₜ indicates the amount of vessels flowing from node i to node j at time t. An N×N×T communication tensor C where entry Cᵢⱼₜ indicates the amount of communication from node i to node j at time t. The number of clusters is k.
1. Obtain the cluster membership vector d using the Flow Clustering Algorithm above.
2. Construct low resolution vessel flow tensor W (dimension is k×k×T) according to the cluster membership vector d by merging vessel flows V within each cluster.
3. Compute flow transfer entropy from C to W: ATE_{ij→kl}(C_{R}_{ᵢ}_{→R}_{ⱼ}(t),W_{R}_{ₖ}_{→R}_{ₗ}(t)).
4. Identify dependency links by thresholding ATEᵢ_{ⱼ}_{→k}_{ₗ} to obtain dependent clusters.
5. Zoom in (e.g., go back to original high resolution) dependent clusters (which the dependency links point to) and keep low resolution of independent clusters.
   Output. Dependency links, dependent clusters and corresponding multiscale flow.

The output provides a unique abstraction and representation of flow dependency which enable decision making tools (e.g. situation awareness tool in monitoring vessel movements in/out of contested water) to support exploratory analysis (e.g. drill down to high-flow entropy zones based on dependent clusters), to refine units of analysis for tracking purpose (e.g., use corresponding multiscale flow and corresponding dependency links).

(4.8) Multi-Scale Multilayer Information Dynamics Example Result

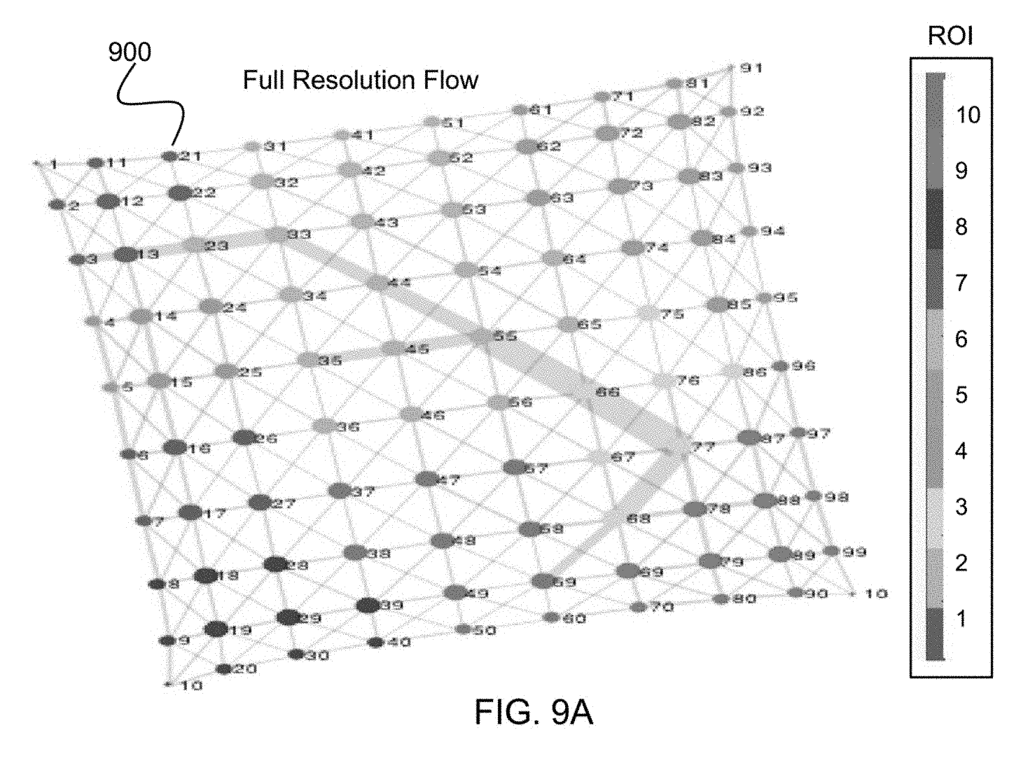

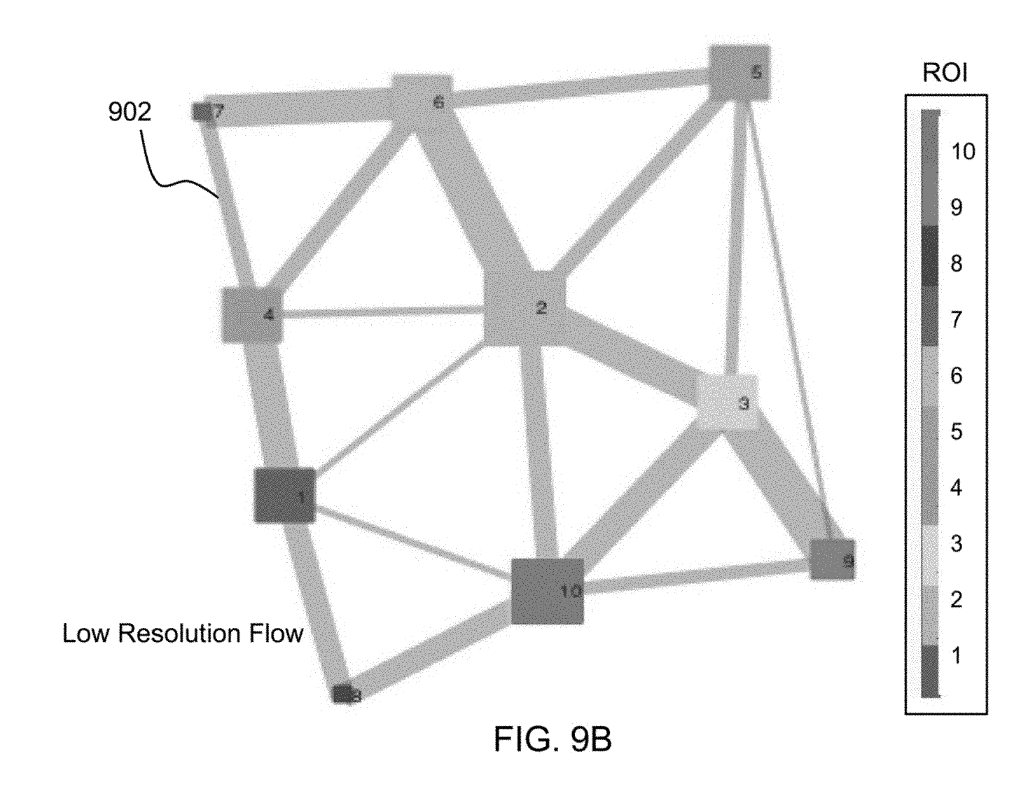

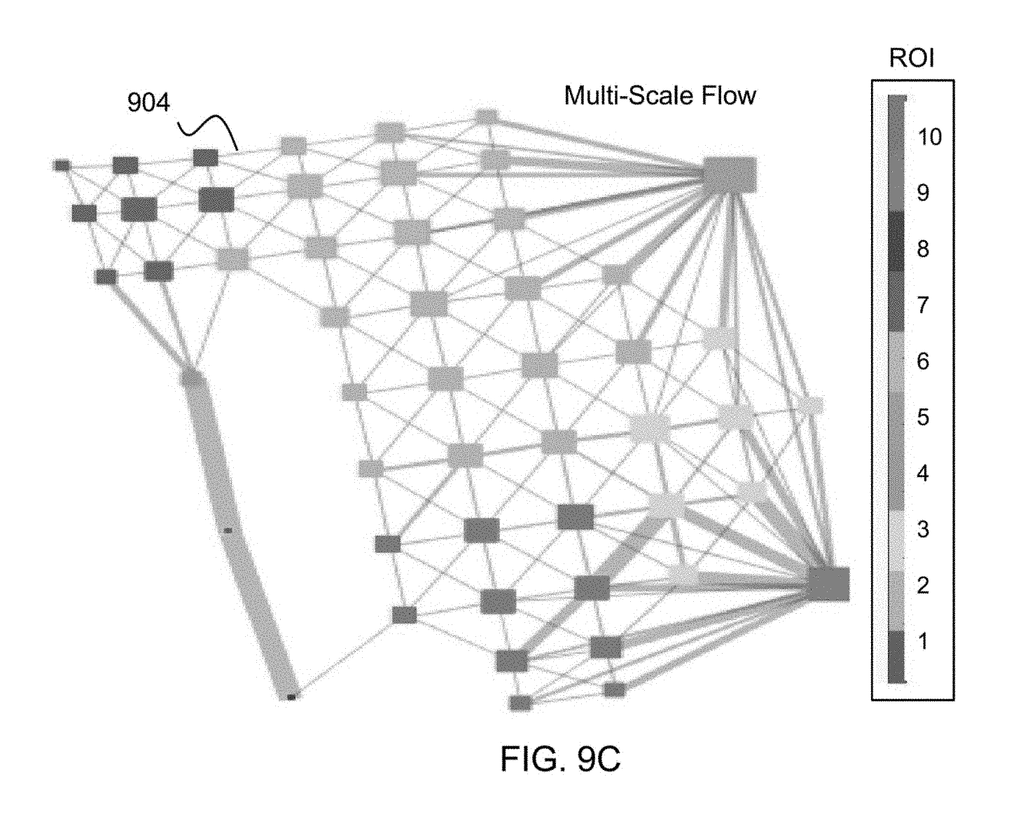

The multi-scale multilayer information dynamic process was performed with the clustered data to further validate the system and process. FIGS. 9A through 9C depict an example of the multi-scale multilayer information dynamics framework. Specifically, FIG. 9A is a snapshot of the vessel flow 900 with a full resolution 10×10 grid (100 nodes), where the thickness of the link represents the amount of vessels flowing from one node to another. FIG. 9B is a snapshot of the summarized vessel flow 902 on the flow cluster graph, where 100 nodes are reduced to 10 clusters, providing a low-resolution flow (after clustering). As shown in FIG. 9C, after applying ATE to the low-resolution vessel flow, a multi-scale vessel flow graph 904 is generated. In this aspect, regions of interest can be cued for multiscale vessel flow monitoring. For example, the system can zoom-into regions of interest while maintaining sufficient monitoring of low interest regions. FIG. 9C provides a snapshot of the multiscale vessel flow 904 where the dependent clusters (dependent on communications) have the original resolution and the rest have the low resolution.

(4.9) Control of a Device.

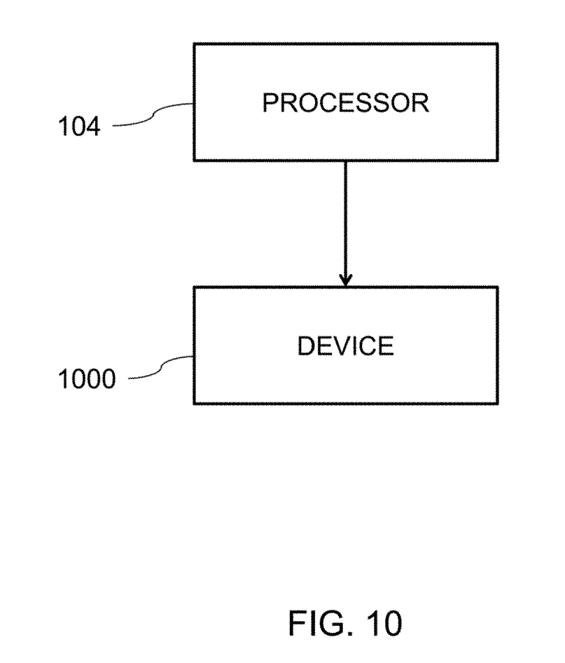

As shown in FIG. 10, a processor 104 may be used to control a device 1000 (e.g., a mobile device display, a virtual reality display, an augmented reality display, a computer monitor, a motor, a machine, a drone, a camera, etc.) based on generating the multi-scale vessel flow graph. For example, a drone or other autonomous vehicle may be controlled to move to an area within the multi-scale vessel flow graph based on identified dependent flows/clusters or their changes over time. For example, before deploying drones to contested water, the system can generate the multi-scale vessel graph by applying the algorithm on data collected via satellites, determine regions of interest with thresholds (e.g., a significant deviation/changes in flow-dependency within a priori-determined time window), and send drones to the regions of interest to collect finer-grained data, or perform monitoring and tracking with desired level of coverage (e.g., zone size) for given constraints (e.g., # of drones available, processing powers, etc.). In yet some other embodiments, a camera may be controlled to orient towards the region of interest and zoom in as needed. In other words, actuators or motors are activated to cause the camera (or sensor) to move or zoom in on the region of interest. For example, the system can be connected with or otherwise incorporated into a satellite as one-level of monitoring (more holistic, passive), such that upon identifying a region of interest, the surveillance apparatus (cameras, sensors, etc.) can be caused to focus on or otherwise zoom into the region of interest. In the drone example, drones as more active and provide fine-grained monitoring (especially under occluded conditions per adversarial intent and actions). Thus, a drone or unmanned aerial vehicle, can be caused to drive or otherwise move to the region of interest for further surveillance.

Finally, while this invention has been described in terms of several embodiments, one of ordinary skill in the art will readily recognize that the invention may have other applications in other environments. For example, while the system was described with respect to an ocean vessel, the system is not intended to be limited thereto and can be equally applied to an area in which objects may be mobile, such as automobiles in a street, people in a battlefield, etc. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. A system for multiscale monitoring, the system comprising:
one or more processors and a memory, the memory being a non-transitory computer-readable medium having executable instructions encoded thereon, such that upon execution of the instructions, the one or more processors perform operations of:
receiving surveillance data of a scene having a plurality of zones, the surveillance data having an object flow tensor V indicating a number of objects flowing from one zone to another zone at time t and an object communication tensor C indicating a number of communications sending from one zone to another zone at time t;
determining a cluster membership of the plurality of zones;
determining dependency links between communications and flows;
designating at least one cluster of one or more zones as a region of interest based on the dependency links; and
controlling a device based on the region of interest.

2. The system as set forth in claim 1, wherein determining a cluster membership of the plurality of zones further comprises operations of:
constructing an adjacency matrix A based on the object flow tensor V;
symmetrizing the adjacency matrix A;
solving nonnegative matrix factorization of the symmetrized adjacency matrix; and
assigning cluster membership of the objects in each of the plurality of zones to generate the cluster membership.

3. The system as set forth in claim 2, wherein determining dependency links between communications and flows further comprises operations of:
constructing a low-resolution flow tensor based on the cluster membership by merging vessel flows V within each cluster;
determining flow transfer entropy; and
identifying dependency links and dependent clusters by thresholding.

4. The system as set forth in claim 3, wherein designating at least one cluster of one or more zones as a region of interest based on the dependency links includes designating the dependent clusters as regions of interest.

5. The system as set forth in claim 4, wherein controlling a device based on the region of interest further comprises causing an unmanned aerial vehicle to move to the region of interest.

6. The system as set forth in claim 4, wherein controlling a device based on the region of interest further comprises causing surveillance apparatus in a satellite to zoom into the region of interest.

7. The system as set forth in claim 1, wherein controlling a device based on the region of interest further comprises causing an unmanned aerial vehicle to move to the region of interest.

8. The system as set forth in claim 1, wherein controlling a device based on the region of interest further comprises causing surveillance apparatus in a satellite to zoom into the region of interest.

9. A computer program product for multi scale monitoring, the computer program product comprising:
a non-transitory computer-readable medium having executable instructions encoded thereon, such that upon execution of the instructions by one or more processors, the one or more processors perform operations of:
receiving surveillance data of a scene having a plurality of zones, the surveillance data having an object flow tensor V indicating a number of objects flowing from one zone to another zone at time t and an object communication tensor C indicating a number of communications sending from one zone to another zone at time t;
determining a cluster membership of the plurality of zones;
determining dependency links between communications and flows;
designating at least one cluster of one or more zones as a region of interest based on the dependency links; and
controlling a device based on the region of interest.

10. The computer program product as set forth in claim 9, wherein determining a cluster membership of the plurality of zones further comprises operations of:
constructing an adjacency matrix A based on the object flow tensor V;
symmetrizing the adjacency matrix A;
solving nonnegative matrix factorization of the symmetrized adjacency matrix; and
assigning cluster membership of the objects in each of the plurality of zones to generate the cluster membership.

11. The computer program product as set forth in claim 10, wherein determining dependency links between communications and flows further comprises operations of:
constructing a low-resolution flow tensor based on the cluster membership by merging vessel flows V within each cluster;
determining flow transfer entropy; and
identifying dependency links and dependent clusters by thresholding.

12. The computer program product as set forth in claim 11, wherein designating at least one cluster of one or more zones as a region of interest based on the dependency links includes designating the dependent clusters as regions of interest.

13. The computer program product as set forth in claim 12, wherein controlling a device based on the region of interest further comprises causing an unmanned aerial vehicle to move to the region of interest.

14. The computer program product as set forth in claim 12, wherein controlling a device based on the region of interest further comprises causing surveillance apparatus in a satellite to zoom into the region of interest.

15. The computer program product as set forth in claim 9, wherein controlling a device based on the region of interest further comprises causing an unmanned aerial vehicle to move to the region of interest.

16. The computer program product as set forth in claim 9, wherein controlling a device based on the region of interest further comprises causing surveillance apparatus in a satellite to zoom into the region of interest.

17. A computer implemented method for multiscale monitoring, the method comprising an act of:
causing one or more processors to execute instructions encoded on a non-transitory computer-readable medium, such that upon execution, the one or more processors perform operations of:
receiving surveillance data of a scene having a plurality of zones, the surveillance data having an object flow tensor V indicating a number of objects flowing from one zone to another zone at time t and an object communication tensor C indicating a number of communications sending from one zone to another zone at time t;
determining a cluster membership of the plurality of zones;
determining dependency links between communications and flows;
designating at least one cluster of one or more zones as a region of interest based on the dependency links; and
controlling a device based on the region of interest.

18. The method as set forth in claim 17, wherein determining a cluster membership of the plurality of zones further comprises operations of:
constructing an adjacency matrix A based on the object flow tensor V;
symmetrizing the adjacency matrix A;
solving nonnegative matrix factorization of the symmetrized adjacency matrix; and
assigning cluster membership of the objects in each of the plurality of zones to generate the cluster membership.

19. The method as set forth in claim 18, wherein determining dependency links between communications and flows further comprises operations of:
constructing a low-resolution flow tensor based on the cluster membership by merging vessel flows V within each cluster;
determining flow transfer entropy; and
identifying dependency links and dependent clusters by thresholding.

20. The method as set forth in claim 19, wherein designating at least one cluster of one or more zones as a region of interest based on the dependency links includes designating the dependent clusters as regions of interest.

21. The method as set forth in claim 20, wherein controlling a device based on the region of interest further comprises causing an unmanned aerial vehicle to move to the region of interest.

22. The method as set forth in claim 20, wherein controlling a device based on the region of interest further comprises causing surveillance apparatus in a satellite to zoom into the region of interest.

23. The method as set forth in claim 17, wherein controlling a device based on the region of interest further comprises causing an unmanned aerial vehicle to move to the region of interest.

24. The method as set forth in claim 17, wherein controlling a device based on the region of interest further comprises causing surveillance apparatus in a satellite to zoom into the region of interest.
